(19) United States
(12) Patent Application Publication
(10) Pub. No.: US 2024/0095859 A1
(43) Pub. Date: Mar. 21, 2024

(54) MENTORSHIP INTEGRATED PLATFORM

(71) Applicants: RAMESH JAYACHANDRAN, MATTHEWS, NC (US); BHARATHKUMAR BADRINATH, MATTHEWS, NC (US); THIRUVADI NATARAJAN SUNDARAMOORTHY, MATTHEWS, NC (US)

(72) Inventors: RAMESH JAYACHANDRAN, MATTHEWS, NC (US); BHARATHKUMAR BADRINATH, MATTHEWS, NC (US); THIRUVADI NATARAJAN SUNDARAMOORTHY, MATTHEWS, NC (US)

(21) Appl. No.: 17/964,344

(22) Filed: Oct. 12, 2022

Related U.S. Application Data
(60) Provisional application No. 63/307,805, filed on Feb. 8, 2022.

(51) Int. Cl. G06Q 50/20; G06F 21/33; G06Q 10/10; G06Q 50/00

(52) U.S. Cl. CPC G06Q 50/2057; G06F 21/33; G06Q 10/1053; G06Q 50/01

(57) ABSTRACT

The mentorship integrated platform is a subscription based social media process/Standalone Product/Mobile App. The mentorship integrated platform supports a plurality of clients. The plurality of clients are organized into a plurality of mentees and a plurality of mentors. The mentorship integrated platform matches a mentee with a mentor. The mentorship integrated platform introduces the mentee to the mentor. The mentorship integrated platform supports a relationship between the mentee and the mentor. The mentorship integrated platform evaluates the relationship between the mentee and the mentor. The mentorship integrated platform includes an identification process, a match process, a mentoring process, an opportunity analysis process, a relationship evaluation process, and an identification process.

### CROSS REFERENCES TO RELATED APPLICATIONS

This non-provisional application claims priority under 35 USC 119(e) to United States provisional application U.S. 63/307,805 filed on Feb. 8, 2022, by the inventors: Ramesh Jayachandran, Thiruvadi Natarajan Sundaramoorthy, and Bharathkumar Badrinath. This non-provisional application claims United States provisional application U.S. 63/307,805 in its entirety.

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of organizational models for human resource planning, building and connecting mentors and mentees to a social network, career planning, learning and development, reference validation, recruiting and retained search. (G06Q10/06)

### SUMMARY OF INVENTION

The mentorship integrated platform is a social media platform for SMBs and corporations. The mentorship integrated platform may be a subscription service. The mentorship integrated platform supports a plurality of clients. The plurality of clients are organized into a plurality of mentees and a plurality of mentors. The mentorship integrated platform matches a mentee selected from the plurality of mentees with a mentor selected from the plurality of mentors. The mentorship integrated platform introduces the mentee to the mentor. The mentorship integrated platform creates and supports a relationship between the mentee and the mentor. The mentorship integrated platform evaluates the relationship between the mentee and the mentor. The mentorship integrated platform comprises an identification process, a match process, a mentoring process, a relationship evaluation process, and an opportunity analysis process. The identification process incorporates each client selected from the plurality of clients into the mentorship integrated platform. The match process matches a mentee with a mentor. The mentoring process supports the development of a relationship between the mentor and the mentee. The relationship evaluation process evaluates the effectiveness of the relationship between the mentee and the mentor. The opportunity analysis process provides the mentee with the option to enhance their relationship network by adding to their mentor network.

These together with additional objects, features and advantages of the mentorship integrated platform will be readily apparent to those of ordinary skill in the art upon reading the following detailed description of the presently preferred, but nonetheless illustrative, embodiments when taken in conjunction with the accompanying drawings.

In this respect, before explaining the current embodiments of the mentorship integrated platform in detail, it is to be understood that the mentorship integrated platform is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the mentorship integrated platform.

It is therefore important that the claims be regarded as including such equivalent construction insofar as they do not depart from the spirit and scope of the mentorship integrated platform. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a detailed flowchart of an embodiment of the disclosure.

FIG. 2 is a detailed flowchart of an embodiment of the disclosure.

FIG. 3 is a detailed flowchart of an embodiment of the disclosure.

FIG. 4 is a detailed flowchart of an embodiment of the disclosure.

FIG. 5 is a detailed flowchart of an embodiment of the disclosure.

FIG. 6 is a detailed flowchart of an embodiment of the disclosure.

FIG. 7 is a detailed flowchart of an embodiment of the disclosure.

FIG. 8 is a detailed flowchart of an embodiment of the disclosure.

FIG. 9 is a detailed flowchart of an embodiment of the disclosure.

FIG. 10 is a detailed flowchart of an embodiment of the disclosure.

FIG. 11 is a detailed flowchart of an embodiment of the disclosure.

FIG. 12 is a detailed flowchart of an embodiment of the disclosure.

FIG. 13 is a detailed flowchart of an embodiment of the disclosure.

FIG. 14 is a detailed flowchart of an embodiment of the disclosure.

FIG. 15 is a detailed flowchart of an embodiment of the disclosure.

FIG. 16 is a detailed flowchart of an embodiment of the disclosure.

FIG. 17 is a detailed flowchart of an embodiment of the disclosure.

FIG. 18 is a detailed flowchart of an embodiment of the disclosure.

FIG. 19 is a detailed flowchart of an embodiment of the disclosure.

FIG. 20 is a detailed flowchart of an embodiment of the disclosure.

FIG. 21 is a detailed flowchart of an embodiment of the disclosure.

FIG. 22 is a detailed flowchart of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

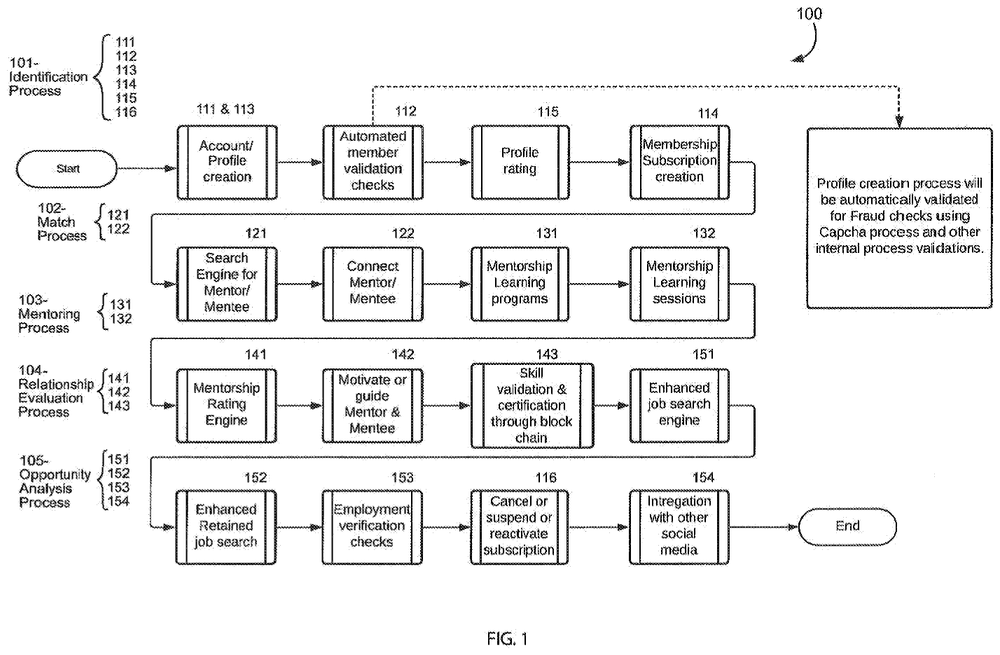

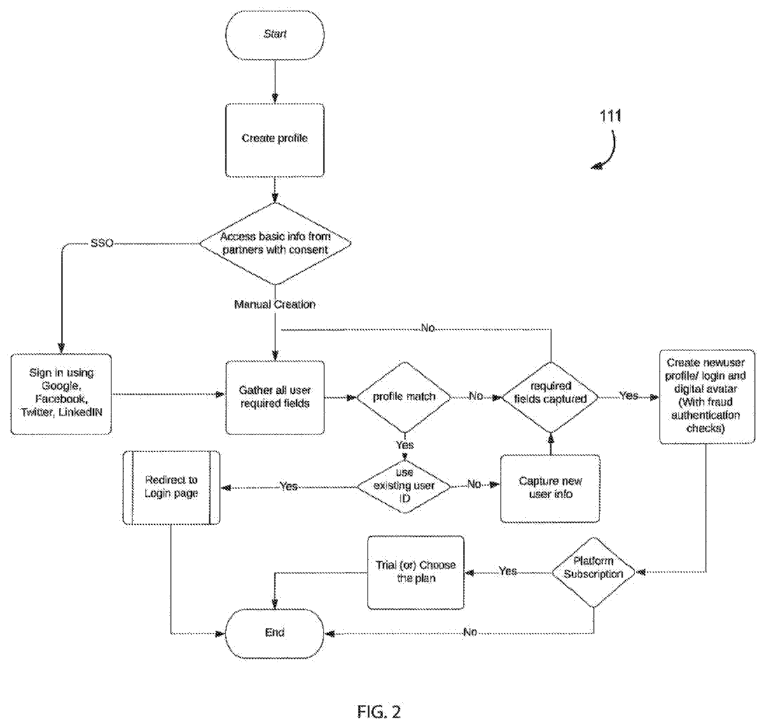

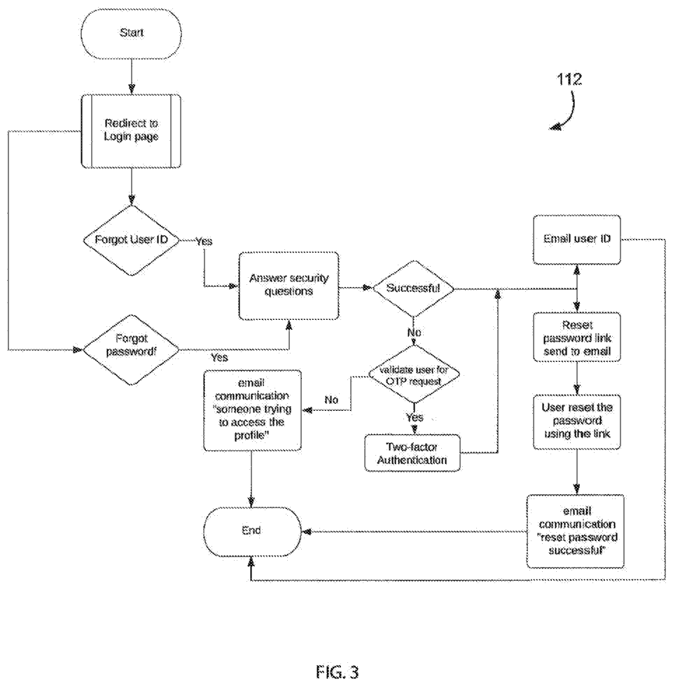

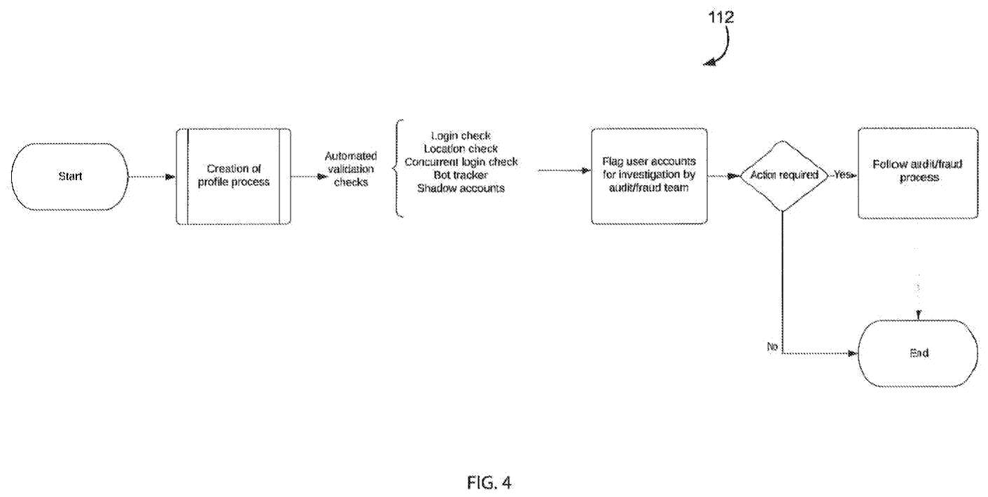

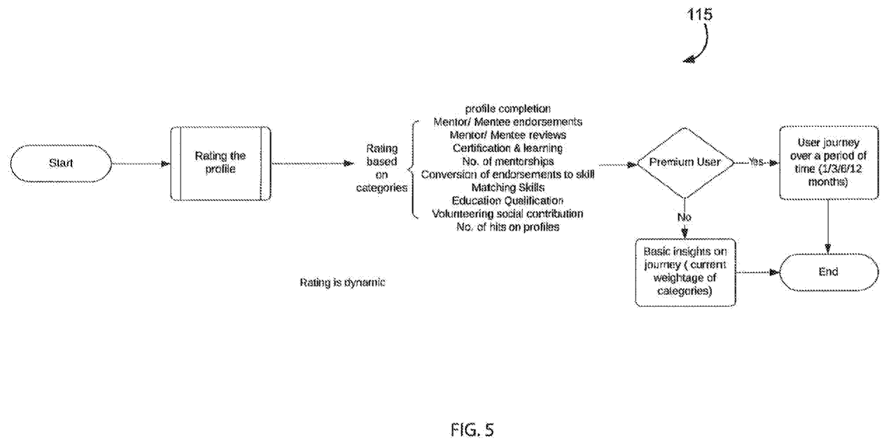

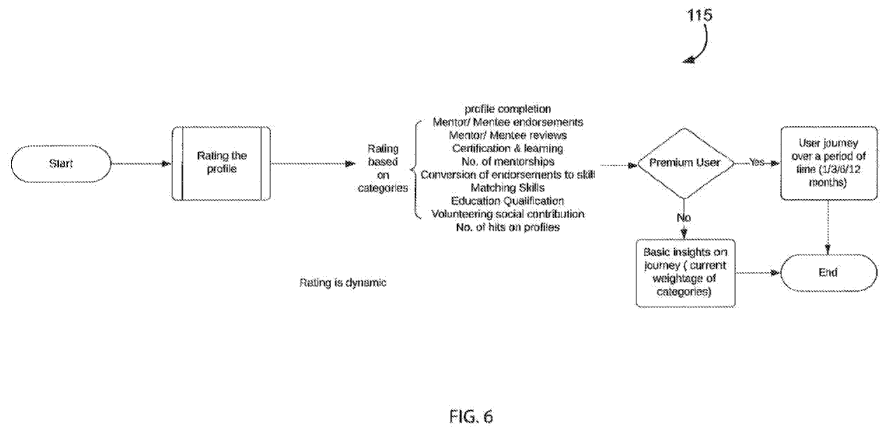

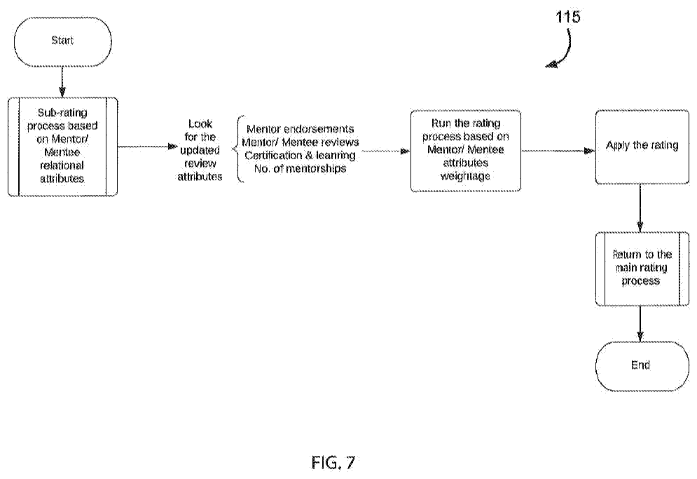

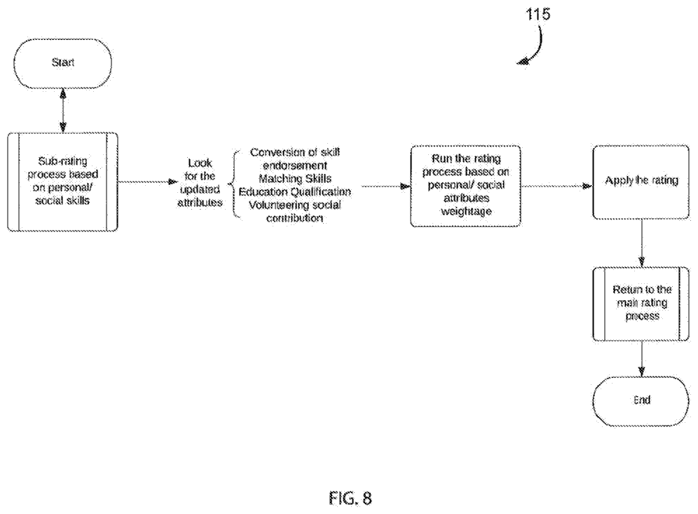

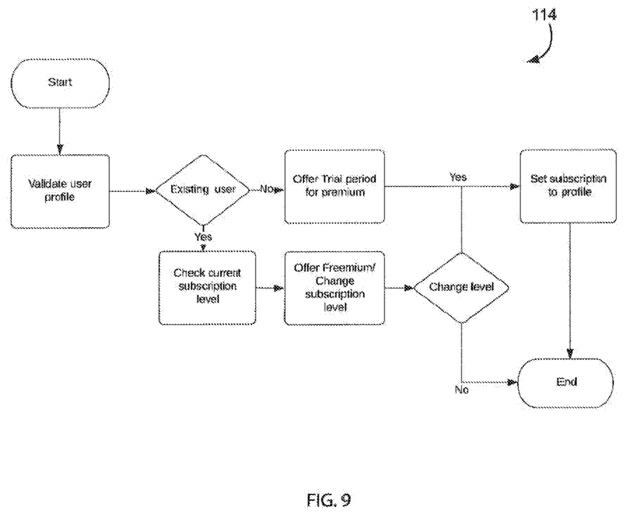

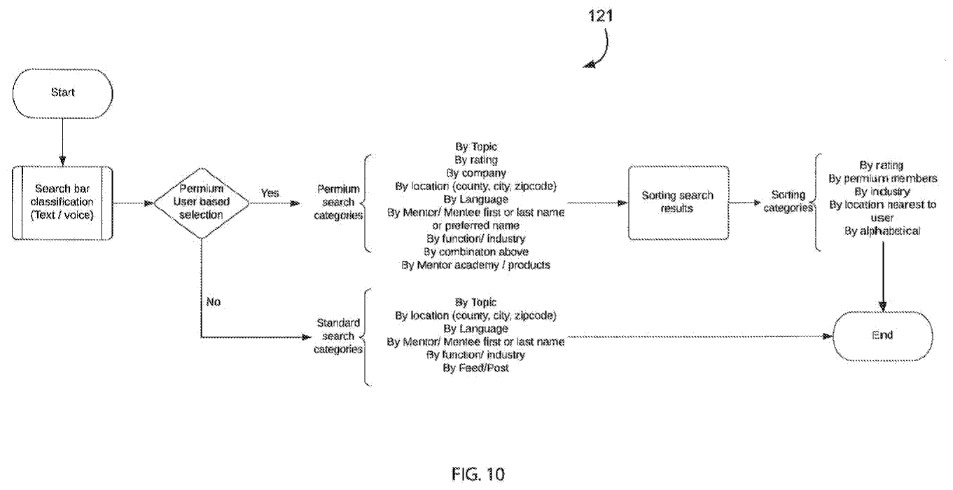

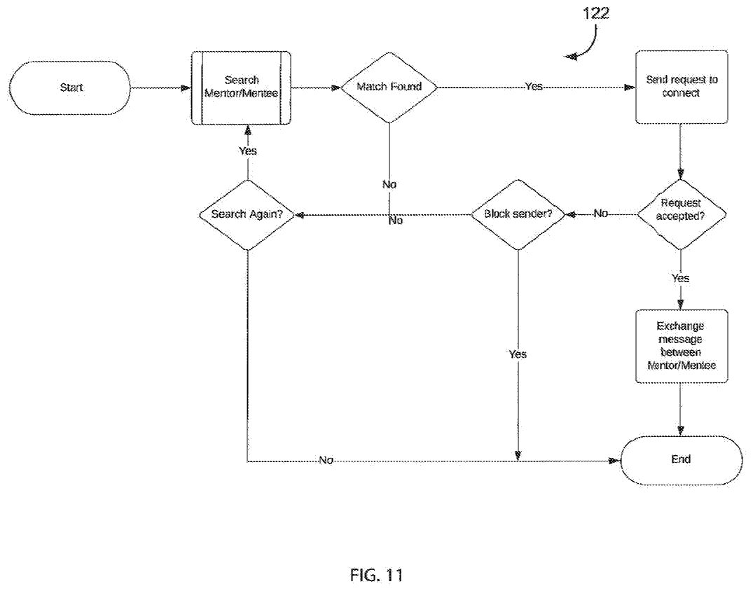

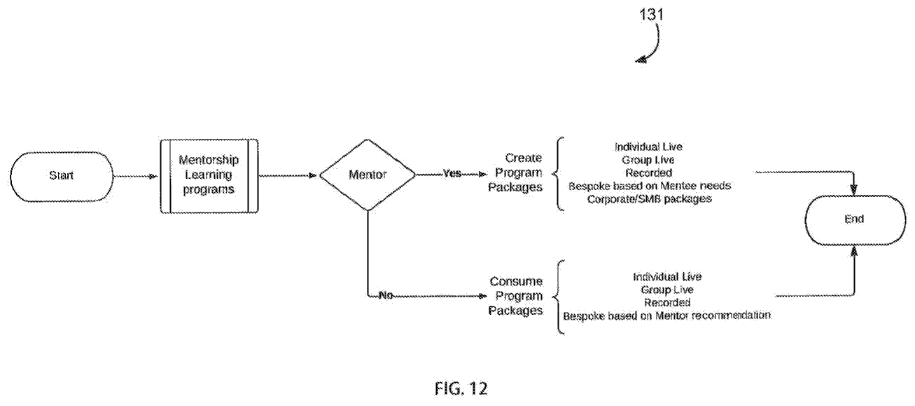

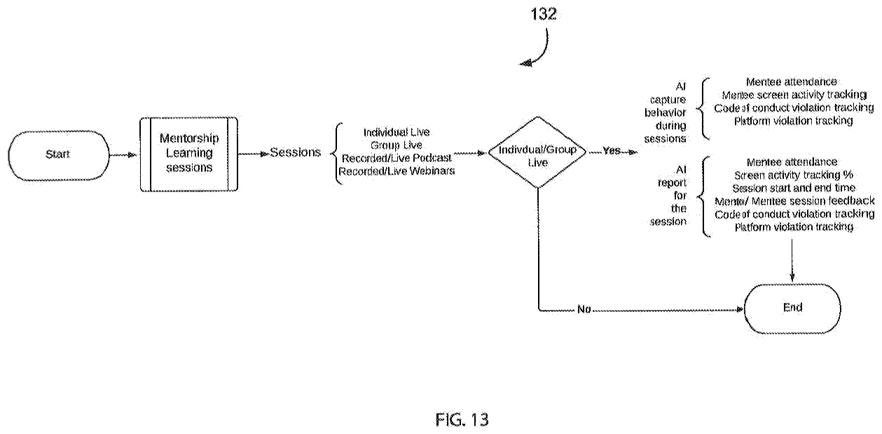

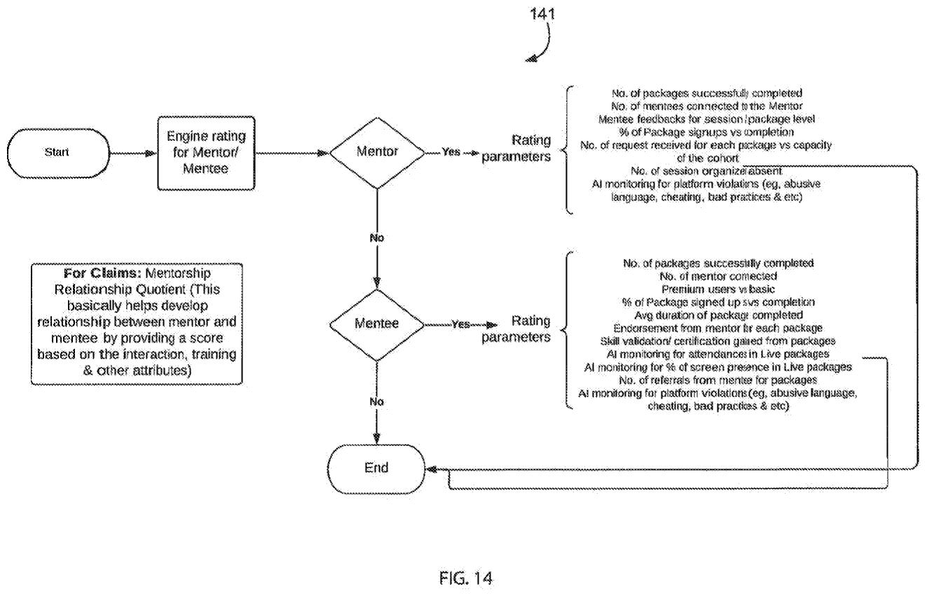

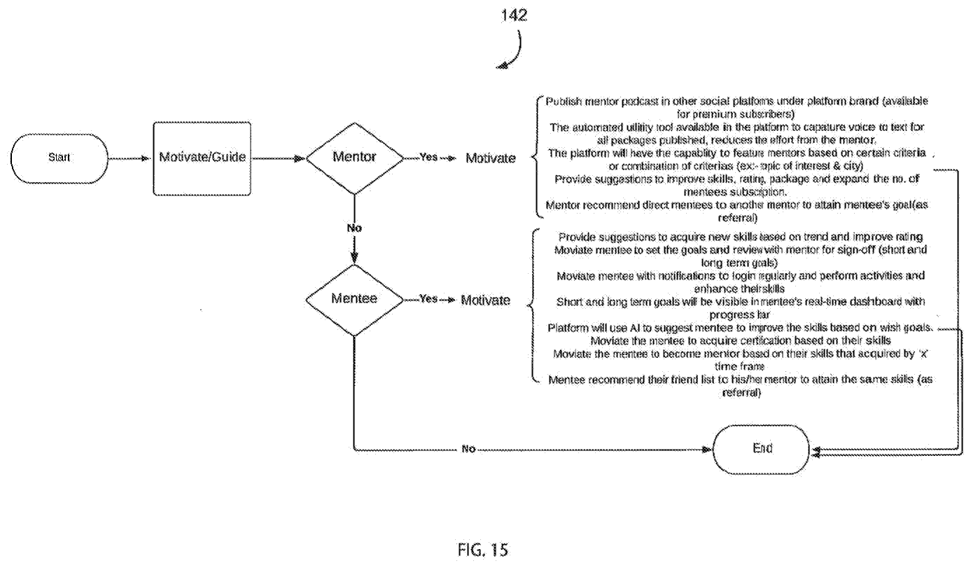

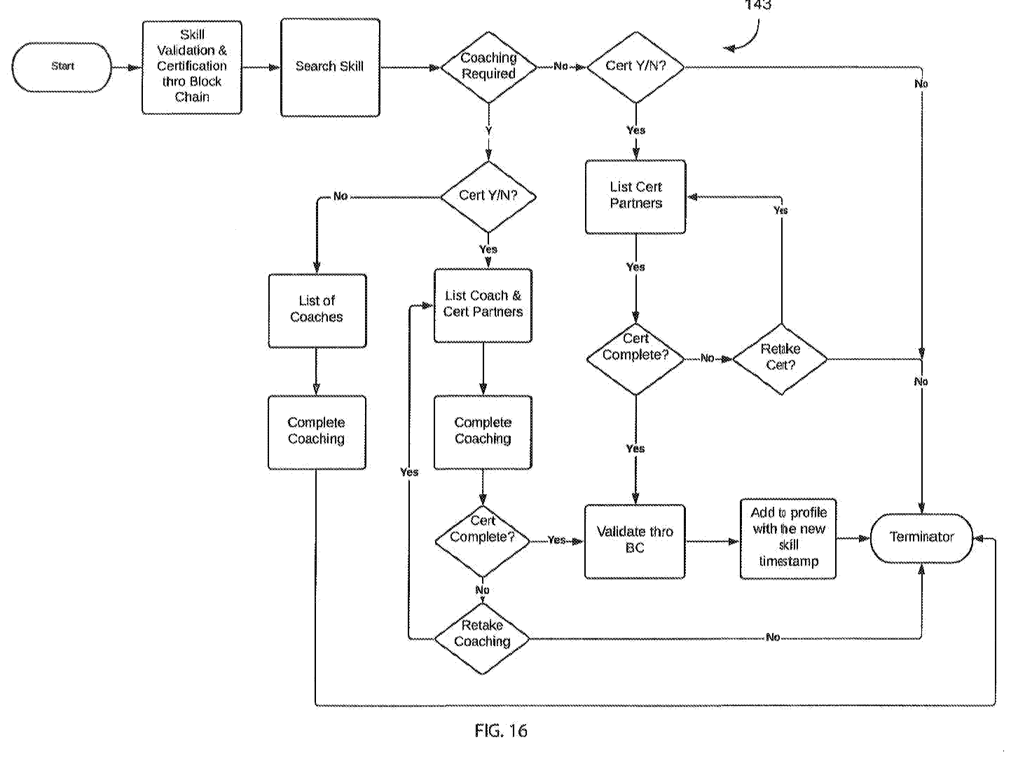

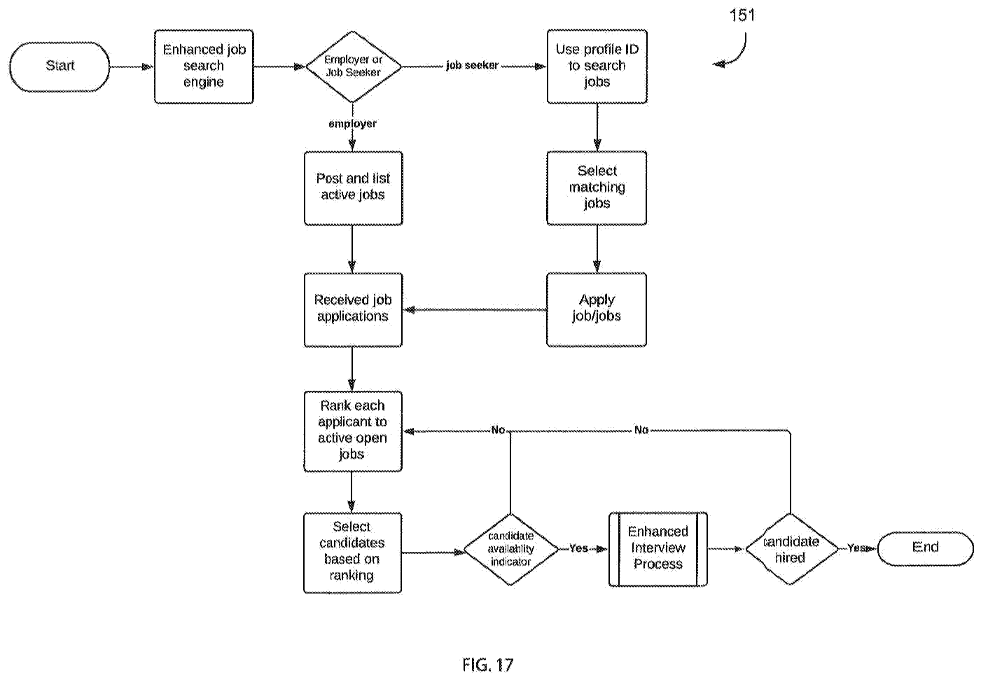

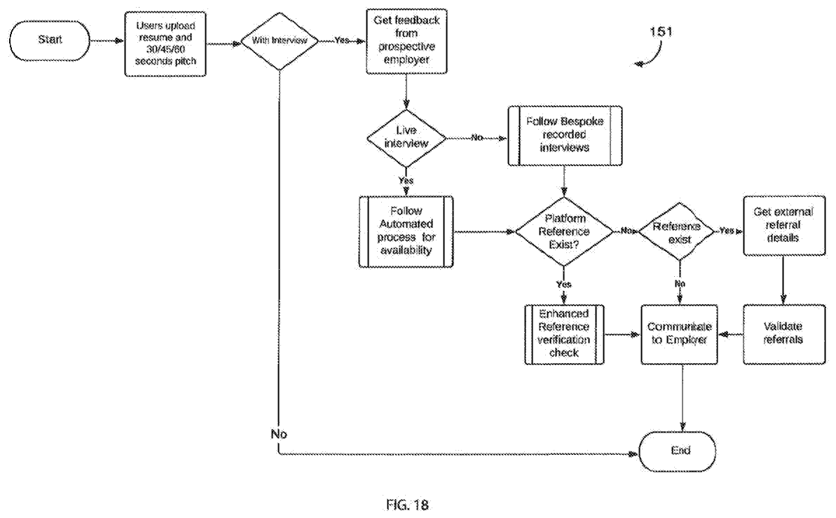

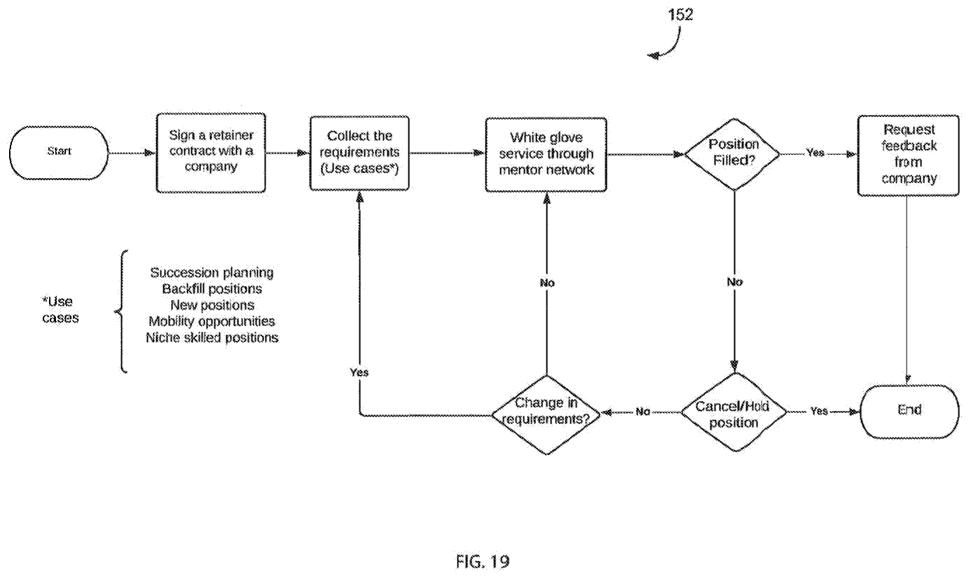

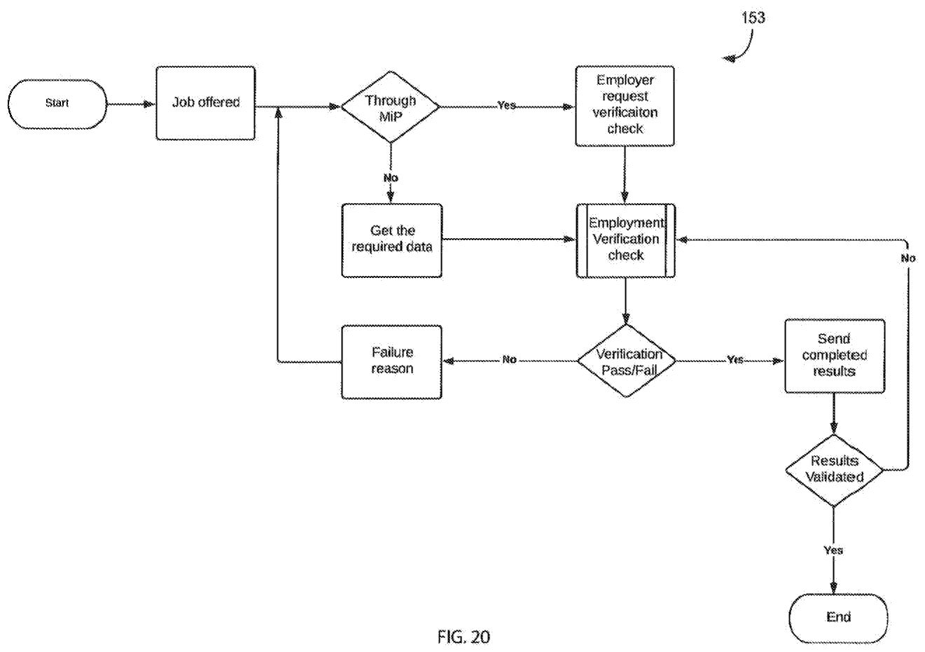

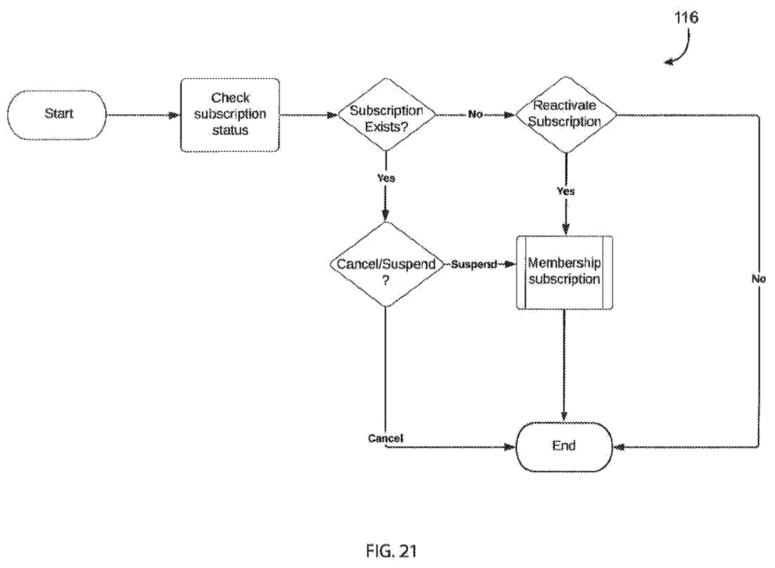

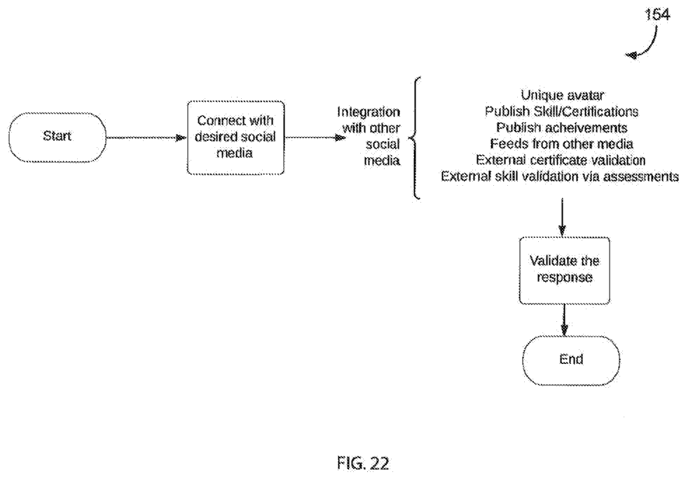

Detailed reference will now be made to one or more potential embodiments of the disclosure, which are illustrated in FIGS. 1 through 22.

The mentorship integrated platform 100 (hereinafter invention) is a process for social media applications. The invention 100 may be a subscription service. The invention 100 supports a plurality of clients. The plurality of clients are organized into a plurality of mentees and a plurality of mentors. The invention 100 matches a mentee selected from the plurality of mentees with a mentor selected from the plurality of mentors. The invention 100 introduces the mentee to the mentor. The invention 100 creates and supports a relationship between the mentee and the mentor.

The invention 100 evaluates the relationship between the mentee and the mentor. The invention 100 comprises an identification process 101, a match process 102, a mentoring process 103, a relationship evaluation process 104, and an opportunity analysis process 105. The identification process 101 incorporates each client selected from the plurality of clients into the invention 100. The match process 102 matches a mentee with a mentor. The mentoring process 103 supports the development of a relationship between the mentor and the mentee. The relationship evaluation process 104 evaluates the effectiveness of the relationship between the mentee and the mentor. The opportunity analysis process 105 provides the mentee with the option to enhance their relationship network by adding to their mentor network and also to include the identification process 101.

The identification process 101 is the first process of the invention 100. The identification process 101 collects the information required to incorporate the client into the processes of the invention 100. The identification process 101 comprises an account creation process 111, an account validation process 112, a profile creation process 113, a subscription selection process 114, and a profile rating process 115.

The account creation process 111 is the initial process of incorporating a client into the processes of the invention 100. The account creation process 111 collects the identification information necessary to allow the processes of the invention 100 to communicate with the client.

The account creation process 111 has the ability to create a new profile login using a unique platform ID linked to the user's digital avatar.

The account validation process 112 is a security and fraud identification process. The account validation process 112 is a verification process that validates the credentials presented by the client during the account creation process 111.

The account validation process 112 has the ability to integrate the user's unique digital avatar and run automated fraud authentication checks.

The account validation process 112 further has the ability to automatically validate Fraud checks using the Captcha process and other internal process validations such as login check, location check, concurrent login check, bot tracker, and shadow accounts• The account validation process 112 has the ability to call out fraud alerts proactively and route them to the fraud team for further investigation and resolution.

The profile creation process 113 is a data collection process. The profile creation process 113 collects personal information about the mentee and the mentor with mutual consent. The personal information collected by the profile creation process 113 creates an individualized profile of the mentee. The individualized profile of the mentee forms the baseline that is used to measure the progress of the mentee towards their goal.

The subscription selection process 114 is the point in the identification process 101 where the contractual obligations with the client are set. The processes of the invention 100 presents the client with the opportunity to choose a contract from a list of available subscription-based contract options.

The profile rating process 115 is a sub-process under the overall rating engine that accounts for multiple attributes that are related to the profile completion. The profile rating process 115 scans for any changes related to the profile attributes at a pre-defined interval and recalculates the rating to apply the changes. The applied changes are displayed in the user dashboard.

The match process 102 is a matching process. The match process 102 evaluates the mentoring needs of each mentee against the abilities of each mentor. The match process 102 selects the best match between the needs of the mentee and the skills and capabilities of the mentor. Once the best available match is identified between the mentee and the mentor via the match process 102 the mentee will have the ability to connect with the mentor via a mentorship request. The match process 102 comprises a match search process 121 and a match introduction process 122. The match search process 121 is the process that formally evaluates the individualized profile of a mentee with the individualized profile of each available mentor to determine the best mentoring match for the mentee. The mentee will have the ability to connect with the mentor via a mentorship request.

The mentoring process 103 is customizable to the needs of the mentor and helps to create/build new skills based on the goals set by the mentor for the mentee. The mentoring process 103 is further defined to include a learning programs 131 and one or more mentoring sessions 132.

Each of the one or more mentoring sessions 132 is a structured relationship building process that allows the mentee and the mentor to form a relationship based on trust. This allows the mentee and the mentor to form a working relationship based on trust. The intention of each of the one or more mentoring sessions 132 is to allow the mentor to share both advice and experience that helps guide the mentee towards their goal. The learning programs 131 is a structured bespoke educational and/or practical environment that is available to the mentee. The learning programs 131 are intended to allow a mentee to develop new skill and/or to strengthen the weak skill identify during the mentorship program. Once the mentee completes the required certification and/or practical training the mentor will have the ability to endorse/rate the mentee's acquired skills. This rating/endorsement can be viewed in the mentee's and mentor's profile and as a new invention the platform will have the ability to date stamp the acquired skill automatically and will be available for reporting for the platform users.

The mentoring process 103 has the ability to motivate and guide Mentor & Mentee engagement using the one or more methods selected from the group consisting of:
a) A Mentor motivation/guide.
b) A published mentor podcasts on other social platforms under platform brands.
c) Automated utility tools available in the platform to capture voice to text for all packages published.
d) A capability to feature mentors based on certain criteria or a combination of criteria.
e) A capability to provide suggestions to improve skills, rating, packages to expand the number of mentee subscriptions.
f) A capability to allow mentors to direct mentees to another mentor.
g) A capability to provide suggestions to acquire new skills based on mentee rating trends.
h) A capability to motivate mentee to set the goals and review with a mentor for sign-off.
i) A capability to motivate mentee with notifications to login regularly and perform activities that enhance the mentee skills and that are visible in mentee's real-time dashboard.
j) An AI capability that suggests to mentees to improve their skills based on stated goals.
k) A capability to motivate the mentee to acquire certifications.
l) A capability to motivate the mentee to become a mentor based on their acquired skills.
m) A capability to accumulate reward points using platform gamification system and redeem within the platform.

The mentoring process 103 is further customized to meet the specific needs described for the following age groups.
14-29 Age group: College application mentorship—Providing the guidance needed from SAT prep to Essay writing and applying to colleges. Providing guidelines on research & projects on early career. More focused activities on social networking platforms.
30-40 Age group: Risk management More focused activities on social networking platforms. Improved job mobility.
40-60 Age group: Improved job mobility. Improved mentorship opportunities. Improved professional networking.
60+ Age group: Improved mentorship opportunities. Improved job mobility. Paying it forward, giving back to the community by volunteering, mentoring, and donating for charitable causes.

The mentoring process 103 further provides the following intercompany services for the benefit of both the mentor and the mentee. These intercompany services include, but are not limited to:
a) A capability to onboard and enable the vendor eco-system to manage and sell custom vendor packages
b) A capability to assign a unique ID/avatar that can be used across social platforms
c) A capability to record individual/group mentorship sessions using consensual automated scribe/voice-to-text transcripts.
d) A capability to record individual/group mentorship sessions, encrypt, store and share with mentor/mentee for their reference.
e) A capability to tailor programs to promote diverse segments the match process matches a mentee with a mentor;
f) A capability to create customized programs and/or packages.
g) A capability to provide individual live sessions, group live sessions, recorded, bespoke programs based on mentee needs, and corporate/SMB packages.
h) A capability for mentees to consume the customized programs and/or packages created by the mentors.
i) A capability to provide individual live sessions, group live sessions, recorded, and bespoke programs based on mentor & mentee recommendations.
j) A capability for AI to capture behavior during sessions.

With user consent, the AI monitors and captures mentee attendance, mentee screen activity tracking, code of conduct violation tracking, and platform violation tracking. The platform has the ability for AI to report behavior after sessions.
k) A capability for AI reports regarding mentee attendance, mentee screen activity tracking percentage, session start and end time, mentor/mentee session feedback, code of conduct violation tracking, and platform violation tracking.

After the relationship between the mentee and the mentor is established, the relationship evaluation process 104 is initiated. The relationship evaluation process 104 is a regularly scheduled process that reevaluates the mentee skills and suggests the mentee for acquiring new/relational skills and related mentors that are available. The relationship evaluation process 104 evaluates the efficacy of the personal interactions between the mentee and the mentor.

The relationship evaluation process 104 evaluates the skills of the mentee to confirm that the mentee has made progress in acquiring the skills set forth between the mentee and mentor is intended to produce. The relationship evaluation process 104 evaluates the skills of the mentee to confirm that the mentee has made progress in improving the skills set forth between the mentee and mentor is intended to produce.

The relationship evaluation process 104 comprises a match review process 141, an interpersonal evaluation process 142, and a skills validation process 143.

The match review process 141 could be a scheduled process that reevaluates and refreshes the mentee and mentor based on the defined rating parameters. The match review process 141 ensures that the match between the mentee and the mentor remains the best match available to the mentee.

The interpersonal evaluation process 142 is an evaluation of the efficacy of the relationship between the mentee and the mentor. The interpersonal evaluation process 142 ensures that the match between the mentee and the mentor will be able to move the mentee towards their goals. The skills validation process 143 is an evaluation that determines the progress of the mentee is making towards the skills being taught through the learning programs 131.

The relationship evaluation process 104 has the ability to rate and rank mentors and mentees based on the measurable parameters.

The measurable parameters available to the relationship evaluation process 104 for the evaluation of the mentor include, but are not limited to:
a) A capability to list, search and find coaching/certification partners.
b) A capability to take coaching through certified partners prior to the certification.
c) A capability to retake certification if the user doesn't meet all the requirements during the certification process on the first attempt.
d) A capability for the user to take certification without coaching.
e) A capability to do skill validation & certification through blockchain.
f) A capability to add the skill completion timestamp to the user profile for the acquired skill/certification.
g) A capability to automate the smart contracts between the platform, mentor & mentee through blockchain.
h) The number of packages successfully completed.
i) The number of mentees connected to the mentor.
j) Mentee feedback for each session and session package.
k) The ratio of session package completions to session package sign ups.
l) The number of session package requests received.
m) The number of platform violations by the mentor.

The measurable parameters available to the relationship evaluation process 104 for the evaluation of the mentee include, but are not limited to:
a) The number of packages successfully completed
b) The number of mentor connections
c) Premium users vs basic users subscription levels.
d) The ratio of session packages completed vs session packages purchased
e) The average time to complete a session package.
f) Endorsement of the mentor for each session package.
g) The number of mentee's interconnected within the MIP's network circle.
h) The skill validation/certification gained from packages
i) The session attendance rate.
j) The measured screen presence rate for each session package.
k) The number. of referrals from mentee for packages.
l) The number of platform violations by the mentee.

The invention 100 further comprises an opportunity analysis process 105 and a third decision. The third decision is an independent process that is mutually exclusive of the opportunity analysis process 105. Moreover, the third decision may be offered to the mentee at the conclusion of each relationship evaluation process 104 to enter into an opportunity analysis process 105 that is provided in conjunction with the processes of the invention 100. The opportunity analysis process 105 is a process that searches for better opportunities for the mentee. The opportunity analysis process 105 provides the opportunity to the mentee to expand their relationship network in a targeted manner. The opportunity analysis process 105 may be further defined with an enhanced job search engine 151, an enhanced retained job search 152, an employment verification checks 153, and an integration with other social media 154.

The enhanced job search engine 151 has several innovations that include: (1) Introductory video profiling; (2) An innovative screening process with recorded bespoke interview questions and an on-demand response capability; (3) Automated calendar management for both the interviewer and the interviewee; (4) Real-time candidate availability indicator; and (5) In addition to the external references, the platform has the ability to get mentor/mentee references.

The Enhanced Retained job search 152 enables: (1) Succession planning for senior/executive leadership positions; (2) White glove service through the mentor and mentee network; (3) The enhanced retained job search engine has the capability to integrate with other ERP and corporate systems.

The Employment verification checks 153 is triggered through a job offer from a specific employer. The employment verification checks 153 triggers a request can be created through the platform directly and communicated to the employer without any external dependencies. The employment verification checks 153 have the capability to do employment verification through the mentor network and vendor/partner networks.

The Integration with social media and other platforms 154 enables integrations between MIP (Mentorship Integrated Platform) with social media and other platforms which includes:
Unique avatar
Publish Skill/Certifications
Publish achievements
Feeds from other media
External certificate validation
External skill validation via assessments.

The measurable parameters available to the opportunity analysis process 105, include, but are not limited to:
a) A capability to match applicants based on skillset percentage fit to open/suitable positions.
b) A capability to rank resumes from the existing companies' database and assess the fit percentage for open/suitable positions.
c) A capability available for the recruiter to flag resumes with comments as a reminder for future reference/use.
d) A capability for the platform to host virtual job fairs and have the ability to do the interviews in a private breakout room within the platform.
e) A capability to provide job fair recruitment data for each job posted for audit purposes either as a report or integrated with the company's preferred HR system.
f) A capability for a self-service tool for the job seekers to publish their availability calendar that is visible to the recruiters to eliminate the step to check the availability to connect.
g) A capability for a self-service tool for the recruiters to publish their availability calendar that is visible to the job seekers to eliminate the step to check the availability to connect.
h) A capability to provide recruitment data for each job posted for audit purposes either as a report or integrated with the company's preferred HR system.
i) A capability to rank the applicants not just only for the applied position but for all the open positions within that company.
j) A capability for showing applicant availability only for selected companies based on applicant preferences.
k) A capability to suggest the recruiter and candidate by matching the applicant's ranking for other open positions within the same company for optimized fit.
l) A capability to close or reopen positions after the selection of candidates.
m) A capability to provide recommendations to suggest a targeted group of candidates by industry based on requirements and select from a hidden pool of talent that is not yet available in the open market.
n) A capability for the job seeker to upload an elevator pitch video for the recruiters to view.
o) A capability for the recruiters to upload templatized/pre-recorded questions related to the job and share the link to the job seeker for the related job.
p) A capability to attend the interviews through a shared link.
q) A capability to provide a link to the recruiter to review the recorded answers.
r) A capability to sort through all resumes and perform an AI match for retained search jobs.
s) A capability to sort through all resumes and perform AI matches to rank against the required or desired skills, which will be used for audit and reporting.
t) A capability to templatize the interview questions in a video format that can be shared with the shortlisted candidates.
u) A capability to do on demand video screening process, where the candidates will have the ability to record their responses to the questions within the prescribed time.
v) A capability to monitor and provide analytics for the recorded responses with predefined attributes.
w) A capability to provide the link of the completed interviews to the employer along with the analytics and/or reporting.
x) A capability to facilitate employers interview scoring evaluation including the capability to connect and validate mentor references within the platform.
y) A capability to facilitate virtual or face to face interview with the shortlisted candidates.

The invention 100 further comprises a plurality of decisions. The plurality of decisions further comprises a first decision and a second decision. The plurality of decisions provides a structured opportunity to determine the needs of the mentee and to select the next step in the process of the invention 100 that best serves the goals of the mentee.

The first decision is a decision point selected from the plurality of decisions. The first decision confirms that the mentee and the mentor both believe that the match is appropriate and that they are both willing to enter the mentoring process 103. If the first decision is the match is agreeable, the mentee and the mentor enter into the mentoring process 103. If the first decision is not agreeable, the mentee will go to the match process 102.

The second decision is a decision point selected from the plurality of decisions. The second decision is a decision made between the mentee and the mentor to continue the mentoring relationship after the completion of the relationship evaluation process 104. If the mentee and the mentor agree to continue the mentoring process 103, the mentee and the mentor reenter the mentoring process 103. If the mentee and the mentor do not agree to continue the mentoring process 103, the mentee returns to the match process 102.

The mentorship relationship may include a mentorship relationship quotient. The mentorship relationship quotient may be a sub-process that is tied to the match review process 141, which already ensures that the match between the mentee and the mentor remains the best match available to the mentee.

The relationship quotient is a sub-process that helps gauge the strength and progress made in terms of developing the mentor/mentee relationships. The relationship quotient is the function of several attributes like the time the relationship is established, the duration of the relationship, the no. of sessions and interactions at a given period of time, the no. of objectives and goals set and achieved in a given period of time, and the no. of mentorship packages signed with the mentor. The following few attributes could affect the relationship quotient
Not having common connect;
Dis-agreement and dis-satisfaction;
On objective completion;
Not having connected sessions for long time;
Unforeseen life circumstances.

The following definitions were used in this disclosure:
Administration: As used in this disclosure, an administration refers to the individual or organization who are responsible for implementing the specific actions required for the operation of an organization or process. The verb form of administration is to administer.
Client: As used in this disclosure, a client is an individual who is designated to receive a service.
Communication Link: As used in this disclosure, a communication link refers to the structured exchange of data between two objects.
Database: As used in this disclosure, a database refers to: 1) a set of data that is organized and stored in a manner that allows for the search and retrieval of data from the data set; or, 2) the electronic device that stores and organizes a data set as described in the first definition.
Field, Records, and Tables: As used in this disclosure, the terms field, record, and table are associated with a database. A field is a single item of information that is maintained by the database. The record refers to a collection of fields that form a related entry within the database. A table refers to a collection of records that are formed with the same field structure. In a relational database, the records contained in a first table contain a first field that is identical to a second field contained in the records of a second table. The use of an identical field allows the user to build meaningful relationship between the first table and the second table.
Include, But Are Not Limited To: As used in this disclosure, the term “include, but are not limited to” is a phrase used to introduce representative examples of structures that meet the requirements of the first phrase. As a first example of the use of the term “include, but are not limited to,” the phrase: “the first textile attaches to the second textile using a fastener such as a hook and loop fastener” is taken to mean that a hook and loop fastener is suitable to use as the fastener but is not meant to exclude the use of a zipper or a sewn seam. As a second example of the use of the term “include, but are not limited to,” the phrase: “the chemical substance is a halogen such as chlorine or bromine” is taken to mean that either chlorine or bromine are suitable for use as the halogen but is not meant to exclude the use of fluorine or iodine.
Information, Data, and Knowledge: As used in this disclosure, the term information refers to a collection of objects that can be reduced to one or more declarative statements. By a declarative statement is meant a statement that is either true or false. The truth value of the statement need not be determined for the declarative statement to be considered information. The term data refers to the collection and organization of information for use as a reference and for subsequent analysis. The term knowledge refers to the context within which information and data are understood. Knowledge can be derived from multiple sources such as a study of the subject and related subject, theoretical analyses of the subject, practical experience, and personal experience with the subject.
Match: As used in this disclosure, to match is a verb that means to associate an initial object selected from a first set of objects to one or more subsequent objects selected from a second set of objects. The association is based on a rule set by one or more known parameters or variables. The concept of matching assumes that there is a one-to-one relationship, or a one-to-one correspondence between the first set of objects and the second set of objects.
Personal Data Device: As used in this disclosure, a personal data device is a handheld logical device that is used for managing personal information and communication. Examples of personal data device include, but are not limited to, cellular phones, tablets, smartphones, and computers.
Real Time: As used in this disclosure, real time refers to the time over which an action or a process occurs. The term real time often implies an immediacy. The term real time also implies that a stimulus (or information) is processed as it occurs.
Social Media: As used in this disclosure, a social media refers to an administered collection of communication links. The social media is accessed through an interface called a site. The social media site is accessed through a personal data device. The social media site organizes and shares information, data, and knowledge with a plurality of clients. A characteristic trait of a social media site is that the information, data, and knowledge is provided by the plurality of clients themselves. The term social media messaging refers to a service provided by the social media site that allows for the exchange of a private/public message between a first client and a second client. A text/audio/video chat room and/or on-demand programs is a service provided by the social media site that allows for the real time exchange of one or more messages between two or more clients of the social media site. My real time is meant that the two or more clients are immediately available to: a) receive the one or more messages; and, b) respond to the one or more messages.
Subscription: As used in this disclosure, a subscription refers to a contractual arrangement for the delivery of a product or access to a service on a recurring basis. The subscribed product or service can be provided on a continuous basis or on a scheduled basis. The term subscription often implies that the subscribed product or service has been paid for in advance.
Such As: As used in this disclosure, the term “such as” is a conjunction that relates a first phrase to a subsequent phrase. The term “such as” is used to introduce representative examples of structures that meet the requirements of the first phrase. As a first example of the use of the term “such as,” the phrase: “the first textile attaches to the second textile using a fastener such as a hook and loop fastener” is taken to mean that a hook and loop fastener is suitable to use as the fastener but is not meant to exclude the use of a zipper or a sewn seam. As a second example of the use of the term “such as,” the phrase: “the chemical substance is a halogen such as chlorine or bromine” is taken to mean that either chlorine or bromine are suitable for use as the halogen but is not meant to exclude the use of fluorine or iodine.
Such That: As used in this disclosure, the term “such that” is a conjunction that relates a first phrase to a subsequent phrase. The term “such that” is used to place a further limitation or requirement to the first phrase. As a first example of the use of the term “such that,” the phrase: “the door attaches to the wall such that the door rotates relative to the wall” requires that the attachment of the door allows for this rotation. As a second example of the use of the term “such that,” the phrase: “the chemical substance is selected such that the chemical substance is soluble in water” requires that the selected chemical substance is soluble in water. As a third example of the use of the term “such that,” the phrase: “the lamp circuit is constructed such that the lamp circuit illuminates when the lamp circuit detects darkness” requires that the lamp circuit: a) detect the darkness; and, b) generate the illumination when the darkness is detected.

With respect to the above description, it is to be realized that the optimum dimensional relationship for the various components of the invention described above and in FIGS. 1 through 22 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A mentorship integrated platform comprising
an identification process, a match process, a mentoring process, a relationship evaluation process, and an opportunity analysis process;
wherein the identification process incorporates each client selected from a plurality of clients into the mentorship integrated platform;
wherein the mentorship integrated platform is a social media platform;
wherein the match process matches a mentee with a mentor;
wherein the mentoring process supports the development of a relationship between the mentor and the mentee;
wherein the relationship evaluation process evaluates the effectiveness of the relationship between the mentee and the mentor;
wherein the opportunity analysis process provides the mentee with the option to enhance their relationship network by adding to their mentor network.

2. The mentorship integrated platform according to claim 1
wherein the mentorship integrated platform is a process;
wherein the plurality of clients are organized into a plurality of mentees and a plurality of mentors;
wherein the mentorship integrated platform matches a mentee selected from the plurality of mentees with a mentor selected from the plurality of mentors;
wherein the mentorship integrated platform introduces the mentee to the mentor;
wherein the mentorship integrated platform creates and supports a relationship between the mentee and the mentor;
wherein the mentorship integrated platform evaluates the relationship between the mentee and the mentor.

3. The mentorship integrated platform according to claim 2
wherein the match process evaluates the mentoring needs of each mentee against the abilities of each mentor;
wherein the match process selects the best match between the needs of the mentee and the abilities of the mentor;
wherein once the best available match is identified between the mentee and the mentor via the match process the mentee will have the ability to connect with the mentor via a mentorship request.

4. The mentorship integrated platform according to claim 3
wherein the match process comprises a match search process and a match introduction process;
wherein the match search process is the process that formally evaluates the individualized profile of a mentee with the individualized profile of each available mentor to determine the best mentoring match for the mentee;
wherein the mentee will have the ability to connect with the mentor via a mentorship request;
wherein the mentoring process is customizable to the needs of the mentor and helps to create/build new skills based on the goals set by the mentor for the mentee.

5. The mentorship integrated platform according to claim 4
wherein the relationship evaluation process is a regularly scheduled process that reevaluates the mentee skills and suggests the mentee for acquiring new/relational skills and related mentors that are available;
wherein the relationship evaluation process evaluates the efficacy of the personal interactions between the mentee and the mentor;
wherein the relationship evaluation process evaluates the skills of the mentee to confirm that the mentee has made progress in acquiring the skills set forth between the mentee and mentor is intended to produce;
wherein the relationship evaluation process includes job search, retained job search, and verification checks; and
wherein the relationship evaluation process evaluates the skills of the mentee to confirm that the mentee has made progress in improving the skills set forth between the mentee and mentor is intended to produce.

6. The mentorship integrated platform according to claim 5
wherein the opportunity analysis process is a process that searches for better opportunities for the mentee;
wherein the opportunity analysis process provides the opportunity to the mentee to expand their relationship network in a targeted manner;
wherein if the mentee and the mentor agree to continue the mentoring process, the mentee and the mentor reenter the mentoring process;
wherein if the mentee and the mentor do not agree to continue the mentoring process, the mentee returns to the match process.

7. The mentorship integrated platform according to claim 6
wherein the identification process comprises an account creation process, an account validation process, and a profile creation process;
wherein the account creation process collects the identification information necessary to allow the processes of the mentorship integrated platform to communicate with the client;
wherein the profile creation process collects personal information about the mentee and the mentor;
wherein the personal information collected by the profile creation process creates an individualized profile of the mentee;
wherein the individualized profile of the mentee forms the baseline that is used to measure the progress of the mentee towards their goal.

8. The mentorship integrated platform according to claim 7
wherein the mentoring process further comprises a learning programs and one or more mentoring sessions;
wherein each of the one or more mentoring sessions is a structured relationship building process that allows the mentee and the mentor to form a relationship based on trust;
wherein this allows the mentee and the mentor to form a working relationship based on trust;
wherein the intention of each of the one or more mentoring sessions is to allow the mentor to share both advice and experience that helps guide the mentee towards their goal;
wherein the learning programs is a structured bespoke educational and/or practical environment that is available to the mentee;
wherein the learning programs are intended to allow a mentee to develop new skill and/or to strengthen the weak skill identify during the mentorship program;
wherein once the mentee completes the required certification and/or practical training the mentor will have the ability to endorse/rate the mentee's acquired skills;
wherein this rating/endorsement can be viewed in the mentee's and mentor's profile and as a new invention the platform will have the ability to date stamp the acquired skill automatically and will be available for reporting for the platform users.

9. The mentorship integrated platform according to claim 8
wherein the relationship evaluation process comprises a match review process, an interpersonal evaluation process, and a skills validation process;
wherein the match review process could be a scheduled process that reevaluates and refreshes the individualized profile of the mentee;
wherein the match review process ensures that the match between the mentee and the mentor remains the best match available to the mentee;
wherein the interpersonal evaluation process is an evaluation of the efficacy of the relationship between the mentee and the mentor;
wherein the interpersonal evaluation process ensures that the match between the mentee and the mentor will be able to move the mentee towards their goals;
wherein the skills validation process is an evaluation that determines the progress of the mentee is making towards the skills being taught through the learning programs.

10. The mentorship integrated platform according to claim 9
wherein the account creation process has the ability to create a new profile login using a unique platform id linked to the user's digital avatar;
wherein the account validation process is a security and fraud identification process;
wherein the account validation process is a verification process that validates the credentials presented by the client during the account creation process;
wherein the account validation process has the ability to integrate the user's unique digital avatar and run automated fraud authentication checks;
wherein the account validation process further has the ability to automatically validate fraud checks using the captcha process and other internal process validations such as login check, location check, concurrent login check, bot tracker, and shadow accounts• the account validation process has the ability to call out fraud alerts proactively and route them to the fraud team for further investigation and resolution.

11. The mentorship integrated platform according to claim 10
wherein the mentoring process has the ability to motivate and guide mentor & mentee engagement using the one or more methods selected from the group consisting of:
a) a mentor motivation/guide;
b) a published mentor podcasts on other social platforms under platform brands;
c) automated utility tools available in the platform to capture voice to text for all packages published;
d) a capability to feature mentors based on certain criteria or a combination of criteria;
e) a capability to provide session package suggestions to improve skills and ratings;
f) a capability to allow mentors to direct mentees to another mentor;
g) a capability to provide suggestions to acquire new skills based on mentee rating trends;
h) a capability to motivate mentee to set the goals and review with a mentor for sign-off;
i) a capability to motivate mentee with notifications to login regularly and perform activities that enhance the mentee skills and that are visible in mentee's real-time dashboard;
j) an AI capability that suggests to mentees to improve their skills based on stated goals;
k) a capability to motivate the mentee to acquire certifications;
l) a capability to motivate the mentee to become a mentor based on their acquired skills;
m) A capability to accumulate reward points using platform gamification system and redeem within the platform.

12. The mentorship integrated platform according to claim 11
wherein mentoring process further provides the following intercompany services for the benefit of both the mentor and the mentee;
wherein these intercompany services are selected from the group consisting of:
a) a capability to onboard and enable the vendor eco-system to manage and sell custom vendor packages;
b) a capability to assign a unique ID/avatar that can be used across social platforms
c) a capability to record individual/group mentorship sessions using consensual automated scribe/voice-to-text transcripts;
d) a capability to record individual/group mentorship sessions, encrypt, store and share with mentor/mentee for their reference;
e) a capability to tailor programs to promote diverse segments the match process matches a mentee with a mentor;
f) a capability to create customized programs and/or packages;
g) a capability to provide individual live sessions, group live sessions, recorded, bespoke programs based on mentee needs, and corporate/SMB packages;
h) a capability for mentees to consume the customized programs and/or packages created by the mentors;
i) a capability to provide individual live sessions, group live sessions, recorded, and bespoke programs based on mentor & mentee recommendations;
j) a capability for AI to capture behavior during sessions; with user consent, the AI monitors and captures mentee attendance, mentee screen activity tracking, code of conduct violation tracking, and platform violation tracking; the platform has the ability for AI to report behavior after sessions;
k) a capability for AI reports regarding mentee attendance, mentee screen activity tracking percentage, session start and end time, mentor/mentee session feedback, code of conduct violation tracking, and platform violation tracking.

13. The mentorship integrated platform according to claim 12 wherein the relationship evaluation process has the ability to rate and rank mentors and mentees based on the measurable parameters.

14. The mentorship integrated platform according to claim 13
wherein the measurable parameters available to the relationship evaluation process for the evaluation of the mentor are selected from the group consisting of:
a) a capability to list, search and find coaching/certification partners;
b) a capability to take coaching through certified partners prior to the certification;
c) a capability to retake certification if the user doesn't meet all the requirements during the certification process on the first attempt;
d) a capability for the user to take certification without coaching;
e) a capability to do skill validation & certification through blockchain;
f) a capability to add the skill completion timestamp to the user profile for the acquired skill/certification;
g) a capability to automate the smart contracts between the platform, mentor & mentee through blockchain;
h) the number of packages successfully completed;
i) the number of mentees connected to the mentor;
j) mentee feedback for each session and session package;
k) the ratio of session package completions to session package sign ups;
l) the number of session package requests received;
m) the number of platform violations by the mentor.

15. The mentorship integrated platform according to claim 14
wherein the measurable parameters available to the relationship evaluation process for the evaluation of the mentee are selected from the group consisting of:
a) the number of packages successfully completed;
b) the number of mentor connections;
c) premium users vs basic session package levels;
d) the ratio of session packages completed vs session packages purchased
e) the average time to complete a session package;
f) endorsement of the mentor for each session package;
g) the number of mentee's interconnected within the MIP's network circle;
h) the skill validation/certification gained from packages
i) the session attendance rate;
j) the measured screen presence rate for each session package;
k) the number; of referrals from mentee for packages;
l) the number of platform violations by the mentee.

16. The mentorship integrated platform according to claim 15
wherein the measurable parameters available to the opportunity analysis process, include, but are not limited to:
a) a capability to match applicants based on skillset percentage fit to open/suitable positions;
b) a capability to rank resumes from the existing companies' database and assess the fit percentage for open/suitable positions;
c) a capability available for the recruiter to flag resumes with comments as a reminder for future reference/use;
d) a capability for the platform to host virtual job fairs and have the ability to do the interviews in a private breakout room within the platform;
e) a capability to provide job fair recruitment data for each job posted for audit purposes either as a report or integrated with the company's preferred HR system;
f) a capability for a self-service tool for the job seekers to publish their availability calendar that is visible to the recruiters to eliminate the step to check the availability to connect;
g) a capability for a self-service tool for the recruiters to publish their availability calendar that is visible to the job seekers to eliminate the step to check the availability to connect;
h) a capability to provide recruitment data for each job posted for audit purposes either as a report or integrated with the company's preferred HR system;
i) a capability to rank the applicants not just only for the applied position but for all the open positions within that company;
j) a capability for showing applicant availability only for selected companies based on applicant preferences;
k) a capability to suggest the recruiter and candidate by matching the applicant's ranking for other open positions within the same company for optimized fit;
l) a capability to close or reopen positions after the selection of candidates;
m) a capability to provide recommendations to suggest a targeted group of candidates by industry based on requirements and select from a hidden pool of talent that is not yet available in the open market;
n) a capability for the job seeker to upload an elevator pitch video for the recruiters to view;
o) a capability for the recruiters to upload templatized/pre-recorded questions related to the job and share the link to the job seeker for the related job;
p) a capability to attend the interviews through a shared link;
q) a capability to provide a link to the recruiter to review the recorded answers;
r) a capability to sort through all resumes and perform an AI match for retained search jobs;
s) a capability to sort through all resumes and perform
AI matches to rank against the required or desired skills, which will be used for audit and reporting;
t) a capability to templatize the interview questions in a video format that can be shared with the shortlisted candidates;
u) a capability to do on demand video screening process, where the candidates will have the ability to record their responses to the questions within the prescribed time;
v) a capability to monitor and provide analytics for the recorded responses with predefined attributes;
w) a capability to provide the link of the completed interviews to the employer along with the analytics and/or reporting;
x) a capability to facilitate employers interview scoring evaluation including the capability to connect and validate mentor references within the platform;
y) a capability to facilitate virtual or face to face interview with the shortlisted candidates.

17. The mentorship integrated platform according to claim 16
wherein the mentorship relationship includes a mentorship relationship quotient;
wherein the mentorship relationship quotient is a sub-process that is tied to the match review process;
wherein the relationship quotient is a sub-process that helps gauge a strength and progress made in terms of developing the mentor/mentee relationships;
wherein the relationship quotient is the function of several attributes (a) time a relationship is established, (b) duration of said relationship, (c) no. of sessions and interactions at a given period of time, (d) no. of objectives and goals set and achieved in a given period of time, and (e) the no. of mentorship packages signed with the mentor;
wherein the relationship quotient is adjusted by factors comprising:
(a) not having common connect;
(b) Dis-agreement and dis-satisfaction;
(c) On objective completion;
(d) Not having connected sessions for long time;
(e) Unforeseen life circumstances.
